(19) United States
(12) Patent Application Publication
(10) Pub. No.: US 2008/0237903 A1
(43) Pub. Date: Oct. 2, 2008

(54) METHOD OF MANUFACTURING THERMOPLASTIC RESIN FILM

(75) Inventor: Akira Yamada, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/058,727

(22) Filed: Mar. 30, 2008

(30) Foreign Application Priority Data
Mar. 30, 2007 (JP) 2007-095570

(51) Int. Cl. B29D 11/00; B29C 43/02

(52) U.S. Cl. 264/1.1; 264/519

(57) ABSTRACT

A method of manufacturing a thermoplastic resin film, comprising the steps of:
discharging a molten thermoplastic resin in film form from a die; and
conveying the discharged film by a plurality of multi-staged cooling rollers with the discharged film contacting the rollers to cool the discharged film at multiple stages, wherein
the temperature of surface of a first cooling roller out of the plurality of cooling rollers provided at multiple stages, the first cooling roller being positioned at the most upstream side in the direction in which the film is conveyed, ranges from the glass-transition temperature (Tg) of the thermoplastic resin−40° C. or higher to Tg+30° C. or lower.

### BACKGROUND OF THE INVENTION

1. Field of the Invention

The present invention relates to a method of manufacturing a thermoplastic resin film, and in particular, to a method of manufacturing thermoplastic resin film used in optical applications such as a liquid display device.

2. Description of the Related Art

Thermoplastic resin such as cellulosic resin and cyclic-olefin-based resin has been extensively used as a film for optical applications. In particular, a film made from cellulosic resin or cyclic-olefin-based resin has been used as an optical film for a liquid display device from the viewpoint of its transparency, toughness and optical isotropy.

As a method of manufacturing a thermoplastic resin film, there has been known a melt film forming method in which molten thermoplastic resin is discharged in film form from a die and the discharged film is conveyed on a plurality of multi-staged cooling rollers while touching the rollers to cool the discharged resin at multiple stages. An unstretched thermoplastic resin film thus manufactured is used as, for example, a protective film for a liquid crystal display device. In addition, a film in which the unstretched thermoplastic resin film is subjected to a stretching process to cause retardation is used as a phase difference film of a liquid crystal display device.

When the film is cooled at the foregoing multiple stages, the film is wrinkled from its shrinkage and expansion caused by change in temperature to degrade the surface characteristics thereof. The degradation of the surface characteristics caused by wrinkles in the thermoplastic resin film particularly used for optical applications is a fatal defect in the optical characteristics, so that a countermeasure for this degradation needs to be taken.

Japanese Patent Application Laid-Open Nos. 2003-33962 and 2003-245966 describe a countermeasure for this degradation. The countermeasure disclosed in Japanese Patent Application Laid-Open No. 2003-33962 is such that, when a film is cooled and solidified by a single roller, the temperature of both ends in the transverse direction of the film is set to be higher than that of its central portion to decrease an optical phase difference. On the other hand, the countermeasure disclosed in Japanese Patent Application Laid-Open No. 2003-245966 is such that a film is cooled at multiple stages by three cooling rollers and the temperature of the cooling roller positioned on the most downstream side is specified to inhibit the generation of wrinkles.

The countermeasures disclosed in Japanese Patent Application Laid-Open Nos. 2003-33962 and 2003-245966 cannot achieve enough the inhibition of wrinkles to satisfy recent strict quality requirements for thermoplastic resin film for optical applications, so that further technical improvements are required. Particularly at the multiple stage cooling process with a plurality of cooling rollers, wrinkles may be produced obliquely with respect to the direction in which the film is conveyed. This problem, however, has not been actually solved yet.

### SUMMARY OF THE INVENTION

The present invention has been made in view of the above situations and for its object to provide a method of manufacturing a thermoplastic resin film best suited for a film for optical applications in such a manner that the generation of wrinkles in the film is decreased as much as possible when the thermoplastic resin film is manufactured by the melt film forming method in which the film is cooled at multiple stages.

To achieve the object a first aspect of the present invention provides a method of manufacturing a thermoplastic resin film comprising the steps of: discharging a molten thermoplastic resin in film form from a die; and conveying the discharged film by a plurality of multi-staged cooling rollers with the discharged film contacting the rollers to cool the discharged film at multiple stages, wherein the temperature of surface of a first cooling roller out of the plurality of cooling rollers provided at multiple stages, the first cooling roller being positioned at the most upstream side in the direction in which the film is conveyed, ranges from the glass-transition temperature (Tg) of the thermoplastic resin−40° C. or higher to Tg+30° C. or lower.

The first aspect of the present invention specifies a contact temperature condition under which the film discharged from the die contacts the cooling roller positioned on the most upstream side in the multiple stage cooling.

According to the first aspect of the present invention, the temperature of surface of the first cooling roller positioned at the most upstream side is set to the vicinity of the glass-transition temperature (Tg) of the thermoplastic resin not to cool suddenly the film, so that the film will not be subjected to a large shrinkage stress when the high-temperature film discharged from the die is cooled at multiple stages by the plurality of the cooling rollers. This effectively inhibits wrinkles from being produced. It is further preferable that the temperature of surface of the first cooling roller ranges from the glass-transition temperature (Tg) of the thermoplastic resin minus (−) 20° C. or higher to Tg+20° C. or lower.

A second aspect according to the first aspect of the present invention is characterized in that if the temperature of surface of the first cooling roller is taken as T1 and the temperature of the film at the time of its contacting the first cooling roller is taken as T2, a temperature difference ΔT represented by T2−T1 is 150° C. or less.

This is because setting a difference in temperature between the film at the time of its contacting the first cooling roller and the roller surface to 150° C. or less in addition to setting the temperature of surface of the first cooling roller positioned at the most upstream side to the vicinity of the glass-transition temperature (Tg) of the thermoplastic resin are more preferable to inhibit wrinkles from being produced.

A third aspect according to the first or the second aspect of the present invention is characterized in that, in the multiple stage cooling, if the temperature of the film passing between the upstream and the downstream cooling roller to be cooled by air is taken as T3 and the temperature of surface of the downstream cooling roller is taken as T4, a relationship of T3≧T4 is satisfied.

The third aspect of the present invention specifies a multiple-stage cooling temperature condition concerning a temperature obtained after the film has contacted the first cooling roller in a multiple-stage cooling using the plurality of cooling rollers provided at multiple stages. This condition was specified based on the finding that wrinkles produced at the multiple stage cooling process are mainly attributed to the fact that the film cooled by the air between the cooling rollers is heated again on the cooling roller which the film contacts next and expanded. The term “air-cooling” refers to a natural cooling in which the film is cooled in the air.

That is to say, according to the third aspect of the present invention, if the temperature of the film passing between the upstream and the downstream cooling roller to be cooled by air is taken as T3 and the temperature of surface of the downstream cooling roller is taken as T4, a relationship of T3≧T4 is satisfied, so that the film cooled by air will not be heated again and expanded on the cooling roller on the downstream side. This effectively inhibits wrinkles from being produced at the multiple stage cooling process.

A fourth aspect according to the third aspect of the present invention is characterized in that the temperature of surface of the plurality of cooling rollers is decreased from the upstream toward the downstream in the direction in which the film is conveyed.

The fourth aspect according to the present invention describes a preferable method for satisfying the above relationship of T3≧T4. The temperature of surface of the plurality of cooling rollers is set to be decreased from the upstream toward the downstream in the direction in which the film is conveyed. This inhibits the film being lower in temperature than the cooling roller on the following downstream side even if the film is cooled by the air while passing between the cooling rollers.

A fifth aspect according to the third or the fourth aspect of the present invention is characterized in that the film is heated between the plurality of the cooling rollers provided at the multiple stages.

The fifth aspect of the present invention describes another preferable method for satisfying the above relationship of T3≧T4, in which the film is heated between the plurality of the cooling rollers. In this case, the film is heated to the extent that the temperature of the film is equal to or slightly higher than that of the cooling roller to satisfy the relationship of T3≧T4. This does not mean to heat the film to the extent that the temperature of the film is excessively higher than that of the cooling roller. In addition, both methods may be applied in which the temperature of surface of the cooling rollers is stepwise reduced from the upstream toward the downstream in the direction in which the film is conveyed and the film is heated.

A sixth aspect according to any one of the third to the fifth aspect of the present invention is characterized in that an air-cooling distance between the plurality of the cooling rollers provided at the multiple stages is 150 mm or less.

The sixth aspect of the present invention describes another preferable method for satisfying the above relationship of T3≧T4, in which an air-cooling distance over which the film travels in the air in the multiple stage cooling is set to be 150 mm or less, thereby inhibiting the film from being lowered in temperature due to cooling by the air. In addition, the following three methods may be applied, 1) the temperature of surface of the cooling rollers is stepwise decreased from the upstream toward the downstream in the direction in which the film is conveyed, 2) the film is heated and 3) an air-cooling distance is set to be 150 mm or less.

A seventh aspect according to any one of the first to the sixth aspect of the present invention is characterized in that the thermoplastic resin is cellulosic resin or cyclic-olefin-based resin.

This is because a cellulosic resin film or a cyclic-olefin-based resin film among the thermoplastic resin films is particularly suited for a film for optical applications from the viewpoint of its transparency, toughness and optical isotropy.

An eighth aspect according to any one of the first to the seventh aspect of the present invention is characterized in that the thermoplastic resin film is an optical one used for optical applications.

This is because manufacturing the thermoplastic resin film for optical applications according to the manufacturing method of the present invention allows inhibiting wrinkles as much as possible from being produced to manufacture the optical film excellent in surface characteristics.

According to the method of manufacturing the thermoplastic resin film of the present invention, the generation of wrinkles on the film can be decreased as much as possible at the time of manufacturing the thermoplastic resin film by the melt film forming method in which the film is cooled at multiple stages. Accordingly, the optical film manufactured by the manufacture method of the present invention is excellent in surface characteristics.

### BRIEF DESCRIPTION OF THE DRAWINGS

FIG. 1 is a general schematic diagram of a manufacturing apparatus for carrying out the method of manufacturing the thermoplastic resin film according to the present invention;

FIG. 2 is a schematic diagram illustrating the structure of an extruding machine;

FIG. 3 is a schematic diagram describing multiple-stage temperature conditions;

FIG. 4 is a schematic diagram illustrating a heating device provided to achieve the multiple-stage temperature conditions;

FIG. 5 is a block diagram illustrating the process for longitudinally and the transversely expanding the film manufactured according to the present invention;

FIG. 6 is a table describing the Embodiment A of the present invention; and

FIG. 7 is a table describing the Embodiment B of the present invention.

### DETAILED DESCRIPTION OF THE PREFERRED EMBODIMENTS

The preferable embodiment of a method of manufacturing a thermoplastic resin film according to the present invention is described below with reference to the accompanied drawings.

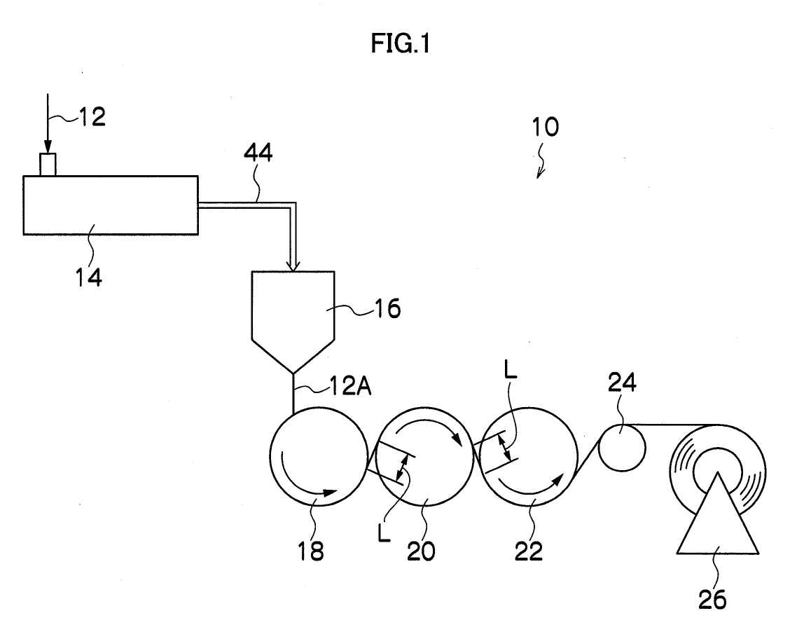

FIG. 1 is a schematic diagram of a manufacturing apparatus for carrying out the method of manufacturing the thermoplastic resin film according to the present invention. Incidentally, although the present embodiment exemplifies the method of manufacturing a cellulose acylate film, the present invention is not limited to this method, but may be applied to other thermoplastic resin films made from cyclic-olefin-based resin.

As illustrated in FIG. 1, a manufacturing apparatus 10 mainly includes an extruding machine 14 for melting cellulose acylate resin 12, a die 16 for discharging molten cellulose acylate resin 12 in film form, a plurality of cooling rollers 18, 20 and 22 for cooling the high-temperature cellulose acylate film 12A (hereinafter referred to as “film 12A”) discharged from the die 16 at multiple stages, a detaching roller 24 for detaching the film 12A from the most downstream cooling roller 22 and a winder 26 for winding the cooled film 12A. Although the cooling rollers 18, 20 and 22 are provided at three stages in FIG. 1, they may be provided at two stages or more.

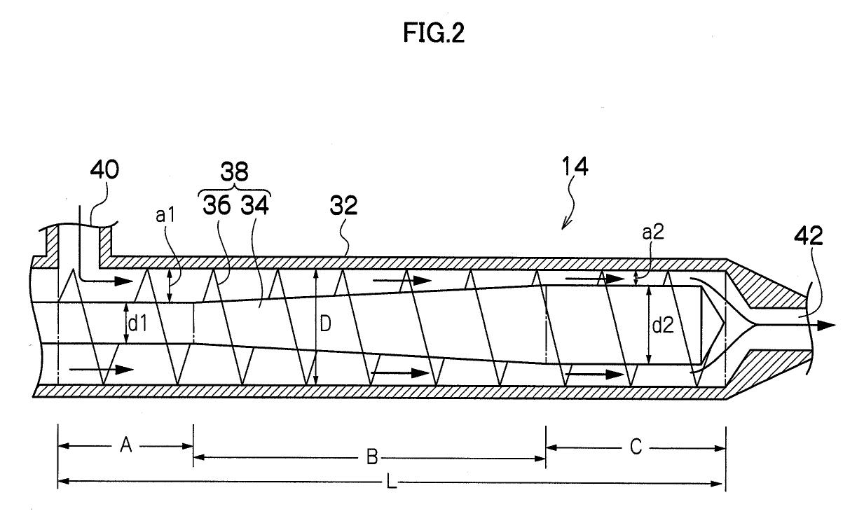

FIG. 2 illustrates the structure of the extruding machine 14. As illustrated in FIG. 2, a single-axis screw 38 in which a flight 36 is attached to a screw axis 34 is provided in a cylinder 32 of the extruding machine 14. The single-axis screw 38 is rotated by a motor (not shown). A supply port 40 of the cylinder 32 is provided with a hopper (not shown) which supplies the cellulose acylate resin 12 to the cylinder 32 through the supply port 40.

The cylinder 32 is composed of a supply section (an area indicated by A) which conveys a constant amount of the cellulose acylate resin supplied through the supply port 40, a compression section (an area indicated by B) which mixes and compresses the cellulose acylate resin and a measurement section (an area indicated by C) which measures the mixed and compressed cellulose acylate resin in the order of from the supply port 40. The cellulose acylate resin melted by the extruding machine 14 is continuously sent from a discharge port 42 to the die 16.

The screw compression ratio of the extruding machine 14 is preferably set to 2.5 to 4.5. An L/D is preferably set to 20 to 70. The term “screw compression ratio” refers to a ratio of the volume of the supply section A to the volume of the measurement section C, that is to say, the screw compression ratio is represented by the volume per unit length of the supply section A divided by the volume per unit length of the measurement section C and calculated by using an outer diameter d1 of the screw axis 34 in the supply section A, an outer diameter d2 of the screw axis 34 in the measurement section C, a channel diameter a1 in the supply section A and a channel diameter a2 in the measurement section C. The term “L/D” refers to a ratio of the length (L) of the cylinder to the bore diameter (D) of the cylinder illustrated in FIG. 2. The extruding temperature is preferably set to 190° C. to 240° C.

The cellulose acylate resin 12 melted by the extruding machine 14 is sent to the die 16 through a pipe 44 (refer to FIG. 1) and discharged in film form from the die discharge port. The rate of variation in the discharging pressure of the die 16 is preferably set to 10% or less.

The high-temperature film 12A discharged from the die 16 is cooled by the three rollers 18, 20 and 22 arranged at multiple stages. The cooling rollers 18, 20 and 22 arranged at three stages are referred to as a first cooling roller 18, a second cooling roller 20 and a third cooling roller 22 respectively in the order of the upstream side in the direction in which the film is conveyed.

In such a multiple stage cooling in the present invention, conditions were set as below: i.e., a contact temperature condition under which the film 12A discharged from the die 16 contacts the first cooling roller 18; and a multiple-stage cooling temperature condition at the process where the film is cooled at multiple stages from the first to the third cooling roller.

### [Contact Temperature Condition]

The temperature of surface of the first cooling roller 18 is set preferably to a range from a glass-transition temperature Tg of the cellulose acylate resin minus (−) 40° C. or higher to Tg+30° C. or lower, more preferably to a range from Tg−20° C. or higher to Tg+20° C. or lower. For instance, for cellulose acylate propionate, its glass-transition temperature Tg is 135° C., so that the temperature of surface of the first cooling roller 18 is set to a range from 115° C. to 155° C. If the temperature of surface of the first cooling roller 18 is taken as T1 and the temperature of the film at the time of its contacting the first cooling roller 18 is taken as T2, a temperature difference ΔT represented by T2−T1 is set to 150° C. or less.

This enables inhibiting the film 12A discharged from the die 16 from being quenched at the time of the film 12A contacting the first cooling roller 18, allowing effectively inhibiting wrinkles in the film 12A from being produced at the time of its contacting. The temperature T1 of surface of the first cooling roller 18 and the temperature T2 of the film at the time of its contacting the first cooling roller 18 may be measured in advance by a preliminary test or a non-contact temperature instrument such as an infrared-ray radiation thermometer may be provided on the manufacturing apparatus to automatically control the temperature of medium of the cooling roller based on the measurement result.

[Multiple-Stage Cooling Temperature Condition]

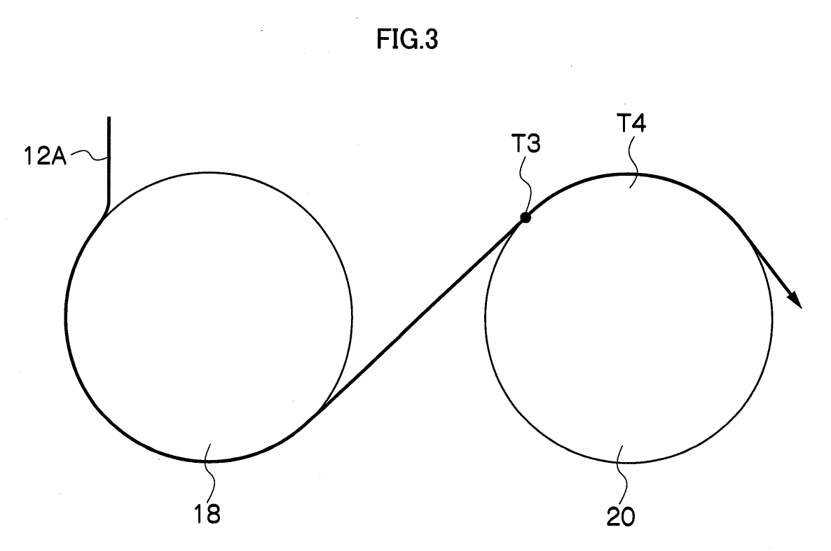

In the multiple stage cooling, if the temperature of the film passing between the upstream and the downstream cooling roller to be cooled by air is taken as T3 and the temperature of surface of the downstream cooling roller is taken as T4, setting is performed to satisfy a relationship of T3≧T4. That is to say, in FIG. 3, the film 12A detached from the first cooling roller 18 is cooled in the air until reaching the second cooling roller 20, and the temperature T3 of the film on the verge of contacting the second cooling roller 20 needs to be kept higher than the temperature T4 of the second cooling roller 20. The same needs to hold true between the second cooling roller 20 and the third cooling roller 22.

Thus, the film 12A will not be heated again on the cooling rollers 20 and 22 to be therefore expanded at the process of multiple stage cooling, enabling effectively inhibiting wrinkles from being produced obliquely with respect to the direction in which the film 12A is conveyed. The reason oblique wrinkles are produced seems to be that the expansion of the film 12A on the surface of the roller is escapable in the direction in which the film is conveyed, but is hardly escapable in the transverse direction of the film because of contact resistance between the roller surface and the film. For this reason, it is preferable to subject the surface of the second and the third cooling roller 20 and 22 to surface treatment to make the surface of the rollers apt to slip, thereby making the expansion of the film 12A to be escapable in the transverse direction of the film.

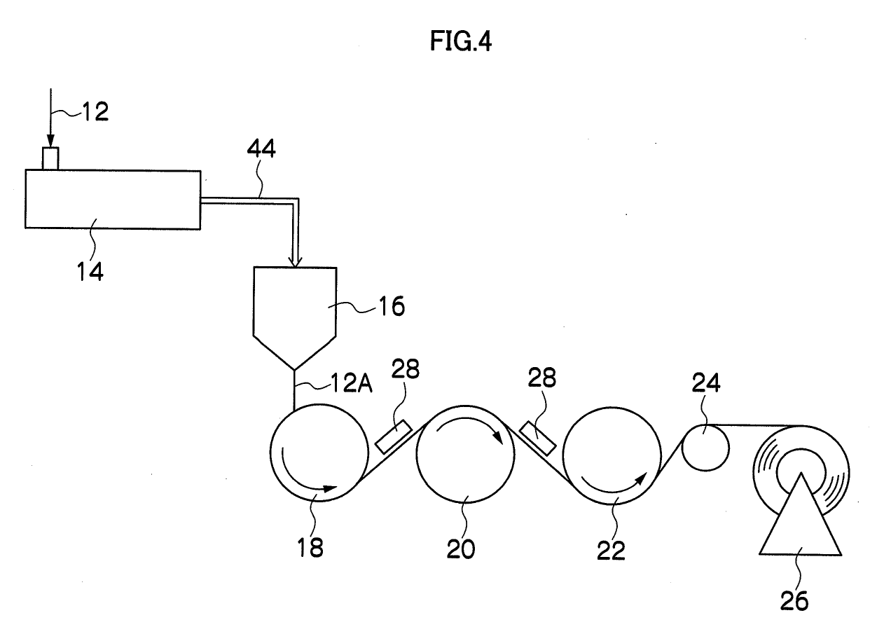

A preferable method of satisfying the relationship of T3≧T4 is described below with reference to FIGS. 1 and 4.

In FIG. 1, the temperature of surface of a plurality of the cooling rollers 18, 20 and 22 is set to stepwise decrease from the upstream toward the downstream in the direction in which the film is conveyed. In this case, it is preferable that a film airs cooling distance L is 150 mm or less between the plurality of the cooling rollers 18, 20 and 22. The term “air-cooling distance L” refers to a distance of a straight line connecting the detaching point on the roller surface where the film 12A is detached from the first cooling roller 18 to the contacting point on the roller surface where the film 12A contacts the second cooling roller 20. The film 12A is cooled by the air in traveling the distance of the straight line.

FIG. 4 is a schematic diagram illustrating another method of satisfying the relationship of T3≧T4, in which a heating device 28 is arranged between the plurality of the cooling rollers 18, 20 and 22 to positively heat the film 12A. A heating device using radiant heat is preferable as the heating device 28. A heating temperature needs to satisfy the relationship of T3≧T4. The temperature T3 of the film is preferably set to be higher by approximately 5° C. than the temperature T4 of the cooling roller, and it is particularly preferable to heat the film so that the temperature T3 becomes equal to the temperature T4.

Furthermore, the following three methods may be used: 1) a method of continually decreasing the temperature of surface of the cooling rollers 18, 20 and 22 from the upstream to the downstream in the direction in which the film is conveyed; 2) a method of heating the film 12A by the heating device 28; and 3) a method of setting the air-cooling distance to 150 mm or less.

As the multiple-stage cooling temperature condition, the temperature distribution of the film 12A preferably falls within 10° C. or less, more preferably 5° C. or less in the transverse direction of the film cooled at multiple stages by the first to the third cooling rollers 18, 20 and 22. In general, the film 12A discharged from the die 16 is apt to be thicker at both ends in the transverse direction of the film than at the central portion in the transverse direction thereof, so that the both ends are harder to cool than the central portion. For this reason, the cooling capacity at both ends in the transverse direction of the roller (corresponding to the transverse direction of the film) is preferably made greater than that at the central portion on the first to the third cooling roller.

In the method of manufacturing the thermoplastic resin film according to the present invention, the contact temperature condition and the multiple-stage cooling temperature condition have been established as described above in the melt film forming process for producing the film, permitting manufacturing the cellulose acylate film which has fewer wrinkles, is excellent in the surface characteristics and suited for optical applications.

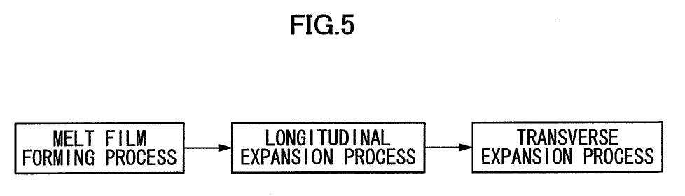

The film 12A thus produced at the melt film forming process can be manufactured as a phase difference film excellent in optical characteristics through a longitudinal expansion process and a transverse expansion process as illustrated in FIG. 5. In this case, the film 12A is produced at the melt film forming process, subsequently processed at the longitudinal and the transverse expansion process without being temporarily wound by a winder 26 and then may be wound by a winder 26.

The film 12A is preheated at the longitudinal expansion process and then wound around two nip rolls with the film 12A heated. The nip roll on the outlet side conveys the film 12A at a faster conveying speed than the nip roll on the inlet side, thereby the film 12A is longitudinally expanded. In this case, it is preferable to subject the film 12A to a long-span expansion such that a heating furnace is provided at the longitudinal expansion process, the nip rollers are arranged at the inlet and the outlet of the heating furnace to expand the film 12A for one second or longer while being evenly heated by the heating furnace. The longitudinally expanded film 12A is sent to the transverse expansion process to be transversely expanded. A tenter, for example, may be suitably used at the transverse expansion process. Both ends of the film 12A in the transverse direction thereof are held by clips of the tenter to expand the film 12A transversely. The transverse expansion allows further increasing retardation Rth.

Subjecting the film 12A to the longitudinal and the transverse expansion process permits obtaining an expanded cellulose acylate film on which the retardations Re and Rth are produced. The retardation Re of the expanded cellulose acylate film is preferably 0 nm or more to 500 nm or less, more preferably 10 nm or more to 400 nm or less, further more preferably 15 nm or more to 300 nm or less. The retardation Rth of the expanded cellulose acylate film is preferably 30 nm or more to 500 nm or less, more preferably 50 nm or more to 400 nm or less, further more preferably 70 nm or more to 350 nm or less. Out of the above values, ones satisfying the relationship of Re≦Rth are more preferable, and ones satisfying the relationship of Re×2≦Rth are more preferable. In order to realize a high retardation Rth and a low retardation Re the longitudinally expanded film is preferably expanded transversely. That is to say, a difference in orientation between the longitudinal and transverse directions is a difference (Re) in in-plane retardation. The film is expanded not only in the longitudinal direction but also in the transverse direction which is orthogonal thereto to reduce a difference in orientation in the longitudinal and transverse directions, enabling a plane orientation (Re) to be reduced. This is because the expansion of the film in the longitudinal and transverse directions increases the multiplying factor of an area, increasing an orientation in the thickness direction as the thickness is decreased to permit the retardation Rth to be increased.

In addition, variations with location in the longitudinal and transverse directions of the retardations Re and Rth are preferably 5% or less respectively, more preferably 4% or less, further more preferably 3% or less. An orientation angle is preferably 90°±5° or less or 0°±5° or less, more preferably 90°±3° or less or 0°±30 or less, further more preferably 90°±1° or less or 0°±1° or less. Bowing can be reduced by performing the expansion process of the present invention. A bowing distortion, in which a deviation at a center portion of a recess into which a straight line drawn along the transverse direction on the surface of the cellulose acylate film 12 before the film enters the tenter is deformed after the film has been expanded is divided by a width, is 10% or less, preferably 5% or less, and more preferably 3% or less.

The present invention is one in which the film is cooled at multiple stages by a plurality of cooling rollers. It is preferable to satisfy the following conditions also in the case where the film is cooled by a single cooling roller. The temperature T1 of surface of the cooling roller is preferably a glass-transition temperature Tg of the cellulose acylate resin minus (−) 40° C. or higher to Tg+30° C. or lower. If a temperature at the time of the film contacting the cooling roller is taken as T2, a temperature difference ΔT represented by T2−T1 is preferably 150° C. or less.

### EMBODIMENTS

### Embodiment A

In an Embodiment A, it was examined how the surface characteristics of the film 12A were improved by executing the contact temperature condition and the multiple-stage cooling temperature condition in the multiple stage cooling of the present invention. The film 12A to be examined was an 80-μm thick cellulose acylate propionate. The glass-transition temperature Tg of the cellulose acylate propionate was 135° C.

The contact temperature condition and the multiple-stage cooling temperature condition are outlined again below.

A first condition: the temperature of surface of the first cooling roller 18 should be a glass-transition temperature (Tg) of the cellulose acylate resin minus (−) 40° C. or higher to Tg+30° C. or lower.

A second condition: if the temperature of surface of the first cooling roller 18 is taken as T1 and the temperature of the film at the time of the film contacting the first cooling roller 18 is taken as T2, a temperature difference ΔT represented by T2−T1 should be 150° C. or less.

A third condition: the temperature of surface of the cooling rollers 18, 20 and 22 should be stepwise decreased from the upstream to the downstream in the direction in which the film is conveyed.

A fourth condition: the film should be heated between a plurality of cooling rollers 18, 20 and 22 provided at multiple stages.

A fifth condition: the film air-cooling distance should be 150 mm or less between the plurality of the cooling rollers 18, 20 and 22 provided at multiple stages.

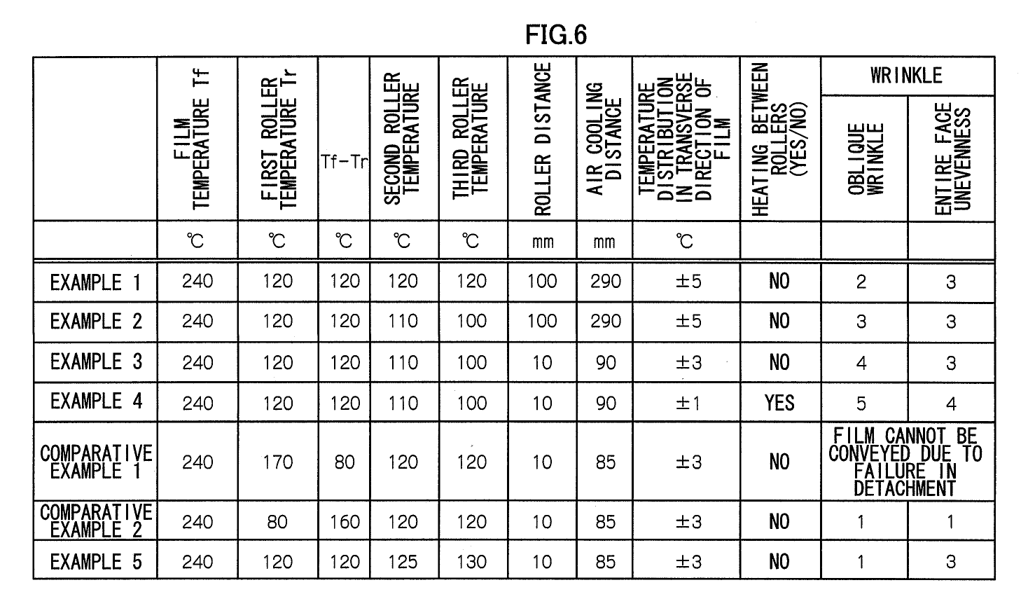

FIG. 6 is a table illustrating examination conditions and results.

Example 1 satisfies the first and second conditions.

Example 2 satisfies the first, second and third conditions.

Example 3 satisfies the first, second, third and fifth conditions.

Example 4 satisfies all of the first, second, third, fourth and fifth conditions.

Example 5 satisfies the first and second conditions.

Comparative Examples 1 and 2 satisfies only the fifth condition.

### [Examination Results]

In FIG. 6, planar wrinkles on the film surface are evaluated in terms of “oblique wrinkle” and “entire-face unevenness” in five degrees. Five (5) is the highest degree.

As can be seen from FIG. 6, the Example 4 satisfying all of the first, second, third, fourth and fifth conditions gained a point “five” in the oblique wrinkle and a point “four” in the entire-face unevenness and produced a very satisfactory result.

The Example 3 satisfying the first, second, third and fifth conditions gained a point “four” in the oblique wrinkle and a point “three” in the entire-face unevenness and produced a satisfactory result.

The Example 2 satisfying the first, second and third conditions gained a point “three” in the oblique wrinkle and a point “three” in the entire-face unevenness and produced a fair result.

The Examples 1 and 5 satisfying the first and second conditions were inferior to the other examples but superior to the Comparative Examples 1 and 2.

On the other hand, in the Comparative Example 1, the temperature of surface of the first cooling roller is higher than the glass-transition temperature Tg of the film by 35° C., so that the film could not be detached from the first cooling roller, as a result, the film could not be cooled at multiple stages. The Comparative Example 2 gained a point “one” both in the oblique wrinkle and in the entire-face unevenness and produced an unsatisfactory result.

As described above, the results were more satisfactory according as the number of the conditions which the examples satisfy increases, the conditions including the first to five ones that are required for the contact temperature condition and the multiple-stage cooling temperature condition of the present invention.

### Embodiment B

In the Embodiment B, the same experiment as in the Embodiment A was conducted using cycloolefin copolymer instead of the cellulose acylate propionate being the resin of the film 12A in the Embodiment A. Cycloolefin copolymer is 80 μm in thickness and its glass-transition temperature Tg is 140° C.

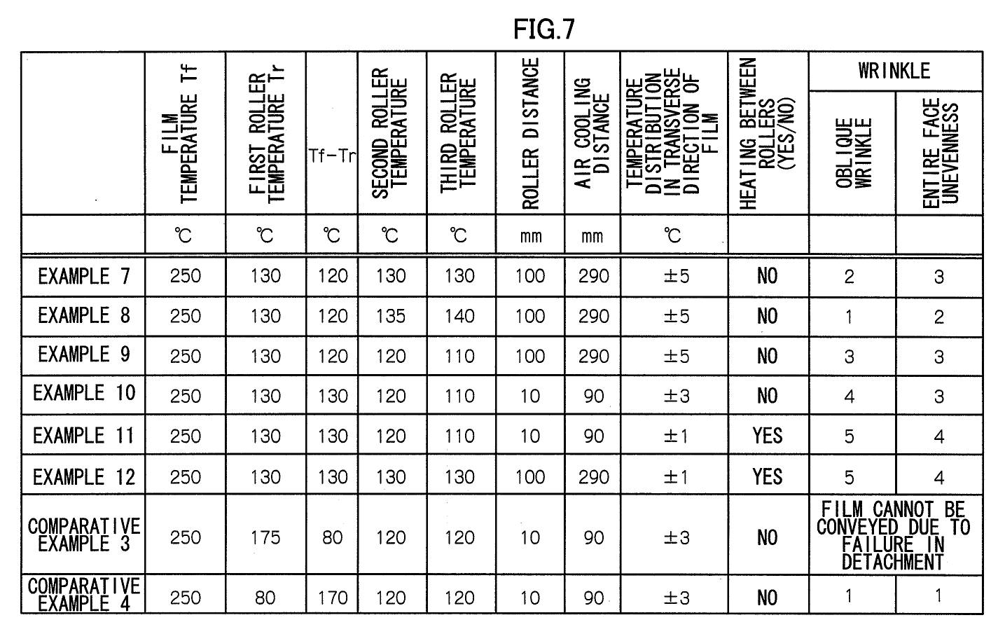

FIG. 7 is a table illustrating examination conditions and results.

Example 7 satisfies the first and second conditions.

Example 8 satisfies the first and second conditions.

Example 9 satisfies the first, second and third conditions.

Example 10 satisfies the first, second, third and fifth conditions.

Example 11 satisfies all of the first, second, third, fourth and fifth conditions.

Example 12 satisfies the first, second and fourth conditions.

Comparative Examples 3 and 4 satisfies only the fifth condition.

### [Examination Results]

As can be seen from the table in FIG. 7, even in the case where the cycloolefin copolymer was used as the resin of the film 12A, the Example 11 satisfying all of the first, second, third, fourth and fifth conditions gained a point “five” in the oblique wrinkle and a point “four” in the entire-face unevenness and produced a very satisfactory result. The results were more satisfactory according as the number of the conditions from the first to five ones which the samples satisfy increases.

On the other hand, in the Comparative Example 3, the temperature of surface of the first cooling roller is higher than the glass-transition temperature Tg of the film by 35° C., so that the film could not be detached from the first cooling roller, as a result, the film could not be cooled at multiple stages. The Comparative Example 4 gained a point “one” both in the oblique wrinkle and in the entire-face unevenness and produced an unsatisfactory result.

Thus, even the Embodiment B brought about the same result as the Embodiment A.

What is claimed is:

1. A method of manufacturing a thermoplastic resin film, comprising the steps of:
discharging a molten thermoplastic resin in film form from a die; and
conveying the discharged film by a plurality of multi-staged cooling rollers with the discharged film contacting the rollers to cool the discharged film at multiple stages, wherein
the temperature of surface of a first cooling roller out of the plurality of cooling rollers provided at multiple stages, the first cooling roller being positioned at the most upstream side in the direction in which the film is conveyed, ranges from the glass-transition temperature (Tg) of the thermoplastic resin−40° C. or higher to Tg+30° C. or lower.

2. The method of manufacturing the thermoplastic resin film according to claim 1, wherein
if the temperature of surface of the first cooling roller is taken as T1 and the temperature of the film at the time of its contacting the first cooling roller is taken as T2, a temperature difference ΔT represented by T2−T1 is 150° C. or less.

3. The method of manufacturing the thermoplastic resin film according to claim 1, wherein
in the multiple stage cooling, if the temperature of the film passing between the upstream and the downstream cooling roller to be cooled by air is taken as T3 and the temperature of surface of the downstream cooling roller is taken as T4, a relationship of T3≧T4 is satisfied.

4. The method of manufacturing the thermoplastic resin film according to claim 3, wherein
the temperature of surface of the plurality of cooling rollers is decreased from the upstream toward the downstream in the direction in which the film is conveyed.

5. The method of manufacturing the thermoplastic resin film according to claim 3, wherein
the film is heated between the plurality of the cooling rollers provided at multiple stages.

6. The method of manufacturing the thermoplastic resin film according to claim 3, wherein
an air-cooling distance between the plurality of the cooling rollers provided at multiple stages is 150 mm or less.

7. The method of manufacturing the thermoplastic resin film according to claim 1, wherein
the thermoplastic resin is cellulosic resin or cyclic-olefin-based resin.

8. The method of manufacturing the thermoplastic resin film according to claim 1, wherein
the thermoplastic resin film is an optical one used for optical applications.
